(19) United States
(12) Patent Application Publication
(10) Pub. No.: US 2008/0040163 A1
(43) Pub. Date: Feb. 14, 2008

(54) System and method for paying and receiving agency commissions

(76) Inventors: James Lacy Harlin, Oklahoma City, OK (US); Steven Riley Hague, Oklahoma City, OK (US); John Thomas Sharpe, Dallas, TX (US)

Correspondence Address: GOODWIN PROCTER LLP, 901 NEW YORK AVENUE, N.W., WASHINGTON, DC, 20001, US

(21) Appl. No.: 10/318,223

(22) Filed: Dec. 13, 2002

(51) Int. Cl. G06Q 40/00; H04M 15/00

(52) U.S. Cl. 705/4; 705/34

(57) ABSTRACT

A system and method for paying a commission to an insurance agent is provided. The method comprises receiving a trail commission from an insurance company, the trail commission being related to or based on a premium paid by a consumer in connection with a product sold by the insurance agent. Next, the method comprises paying the insurance agent the commission in exchange for services provided to the consumer. The invention also comprises a system for paying a commission to an insurance agent. The system comprising an intermediate managing agent interposed between the insurance agent and an insurance company, the intermediate managing agent receiving a trail commission from the insurance company, the trail commission being related to or based on a premium paid by a consumer in connection with a product sold by the insurance agent, the intermediate managing agent further paying the insurance agent the commission in exchange for services provided to the consumer.

### FIELD OF THE INVENTION

This invention relates generally to a system and method for payment and receipt of agency commissions and, more particularly, to a system and method for payment and receipt of agency commissions using an intermediate managing agent.

### BACKGROUND OF THE INVENTION

The concept of agency has long played an important role in the insurance industry. In many cases, the involvement of an agent is required by regulation. The duties and responsibilities of the agent are regulated by state insurance departments. Typically, a writing or insurance agent sells policies and other like products directly to consumers on behalf of an insurance company. Examples of such policies and products include annuities, life insurance, automobile insurance, health insurance, and other like products. For each policy or product sold, the insurance company typically pays the agent an up-front commission equal to a percentage of the premium paid. The percentages vary widely by the type and nature of the product. For example, for a deferred annuity contract sale a typical range of commission is usually between 1% and 12%. Given a commission rate of 6% and a premium of $20,000, therefore, the insurance agent would receive a commission of $1200.

The insurance company may choose to protect its investment made to acquire the new policy. If, for example, the consumer (or policyholder) decides to cancel the policy within a specified period of time, the insurance agent may be required to return to the insurance company all or a portion of the paid commission. This return payment is commonly referred to as a charge-back. Usually, the amount of the charge-back is dependent on when the policy or product is canceled or terminated. It may further depend on the reason for the policy termination (e.g. death versus surrender). For example, a typical charge-back schedule may state as follows: if the policy is canceled within six months of its entry date, the agent will have to return the full commission; between six months and a year, 75% is returned; between a year and 18 months, 50% is returned; between 18 months and 2 years, 25% is returned; after two years, nothing is returned. The charge-back schedule may be specified in the agent contract between the insurance company and the agent, and typically extends over one or two years.

The insurance company may also protect itself by requiring the consumer (or policyholder) to incur a surrender fee for early termination or cancellation of a policy or product. Provision for such a fee may be specified by the terms of the policy or product purchased, and is typically set as a percentage or portion of the premium paid or the policy value withdrawn. Like a charge-back, the surrender fee may gradually decrease with time. For example, a typical surrender fee schedule may provide as follows: if the policy or product is canceled within the first year, the consumer (or policyholder) is charged 6% of the premium; within the second year, 5% is charged; the third year, 4% is charged; the fourth year, 3%; the fifth year, 2%; the sixth year, 1%; etc. Normally, the surrender fee structure extends throughout a longer period of time than the charge-back structure, such as six or seven years, for example.

Though up-front commission payments and charge-back and surrender fee structures are common practice, they nonetheless present several problems. One problem results from conflicting regulations. For instance, as is widely known, insurance companies must comply with various federal and state laws and regulations. State insurance departments, for example, require that an insurance company maintain a certain amount of minimum capital and surplus in order to stay in business. The exact amount is usually determined by absolute minimum requirements or a risk-based capital formula (RBC) that takes into account factors such as the nature of the insurance company's product(s), investments, and the risks being assumed. Typically, the greater the risks assumed the higher the amount of capital and surplus required.

The minimum capital and surplus requirement, however, conflicts with statutory accounting regulations that require insurance companies to report up-front commission payments as expenses when incurred. Specifically, the conflict occurs because the large up-front commission payments to multiple agents has the deleterious effect of lowering the available capital and surplus maintained by the insurance company. As a result, the likelihood increases that the minimum capital and surplus requirement will not be met, and that business opportunities will be constrained.

Another problem concerns the insurance company's inability to fully protect or shield itself from losses resulting from policies or products that are canceled or terminated early. One specific example is the increased risk experienced by the company after the agent is no longer accountable for such early cancellations or terminations, i.e., after expiration of the charge-back schedule. In the example discussed above, this is anytime after the two year-anniversary of the policy or product's initiation date. While the insurance company may still recover from the consumer (or policyholder) via the surrender fee, its ability to recover losses is nonetheless significantly diminished. Furthermore, there is no incentive on the part of the agent to ensure customer satisfaction and/or to discourage early cancellation or termination of policies or products.

These and other problems exist.

### SUMMARY OF THE INVENTION

An object of the present invention is to overcome the aforementioned and other drawbacks existing in prior art systems and methods.

Yet another object of the present invention is to provide a system and method whereby an insurance company reduces or eliminates the risk associated with early policy or product cancellations or terminations.

Another object of the present invention is to provide surplus relief to insurance companies paying commissions to agents.

Yet another object of the present invention is to provide a system and method whereby an insurance company may recognize the cost of agent commissions over an extended period of time.

According to one embodiment of the invention, a method for paying a commission to an insurance agent is provided. The method comprises receiving a trail commission from an insurance company, the trail commission being related to or based on at least one of a premium, a policy account balance, or a policy value amount paid, owed, or held by a consumer in connection with a product sold by the insurance agent. The method next comprises paying the insurance agent the commission in exchange for services provided to the consumer.

In another embodiment, a method for paying a commission is provided. The method comprises paying an intermediate managing agent a trial commission, the trial commission being related to or based on a premium paid by a consumer in connection with a product sold by an insurance agent

In yet another embodiment, a method is provided for receiving a commission. The method comprises receiving the commission payment from an intermediate managing agent in exchange for services rendered to a consumer in connection with the purchasing of an insurance company product.

In another embodiment, the invention comprises a system for paying a commission to an insurance agent. The system comprises a third party intermediate managing agent interposed between the insurance agent and an insurance company, the intermediate managing agent receiving a trail commission from the insurance company, the trail commission being based on a premium paid by a consumer in connection with a product sold by the insurance agent, the intermediate managing agent further paying the insurance agent the commission in exchange for services provided to the consumer.

In yet another embodiment, a method for paying a commission to an insurance agent is provided. The method comprises receiving a trail commission from an insurance company, the trail commission being related to or based on at least one of a premium, a policy account balance, or a policy value amount paid, owed, or held by a consumer in connection with a product sold by the insurance agent. Next, the method comprises paying at least one general managing agent some portion or all of the commission; and paying the insurance agent some or all of the commission in exchange for services provided to the consumer.

In another embodiment, a method for paying a commission to an insurance agent is provided. The method comprises receiving a trail commission from an insurance company, the trail commission being related to or based on at least one of a premium, a policy account balance, or a policy value amount paid, owed, or held by a consumer in connection with a product sold by the insurance agent; and paying at least one general managing agent and an insurance agent some portion or all of the commission.

In yet embodiment, a method for paying a commission to an agent is provided. The method comprises receiving a trail commission from a participant, and paying the agent the commission.

In another embodiment, a system for paying a commission to an agent is provided. The system comprises an intermediate managing agent interposed between the agent and a participant. The intermediate managing agent receiving a trail commission from the participant and paying the agent the commission.

The accompanying drawings, which are incorporated in and constitute a part of this specification, illustrate various embodiments of the invention and, together with the description, serve to explain the principles of the invention.

### BRIEF DESCRIPTION OF THE DRAWINGS

FIG. 1 is a block diagram of the prior art process for paying a commission to an insurance agent;

FIG. 2 is a block diagram illustrating one embodiment of a system for paying a commission to an insurance agent according to the present invention;

FIG. 3 is a block diagram illustrating another embodiment of a system for paying a commission to an insurance agent according to the present invention;

FIG. 4 is a flow chart process for paying a commission to an insurance agent according to the present invention. FIG. 4a is a flow chart process for paying a commission to an insurance agent according to the present invention.

FIG. 4b is a block diagram of a general agent hierarchy according to the present invention.

FIG. 5 is a flow chart process for paying a commission according to the present invention.

FIG. 6 is a flow chart process for receiving a commission according to the present invention.

### DETAILED DESCRIPTION OF THE INVENTION

Reference will now be made to the present preferred embodiments of the invention, examples of which are illustrated in the accompanying drawings in which like reference characters refer to corresponding elements.

The present invention is described in relation to a system and method for paying and receiving insurance agency commissions. Nonetheless, the characteristics and parameters pertaining to the system and method may be applicable to paying and receiving commissions associated with other types of content and/or industries.

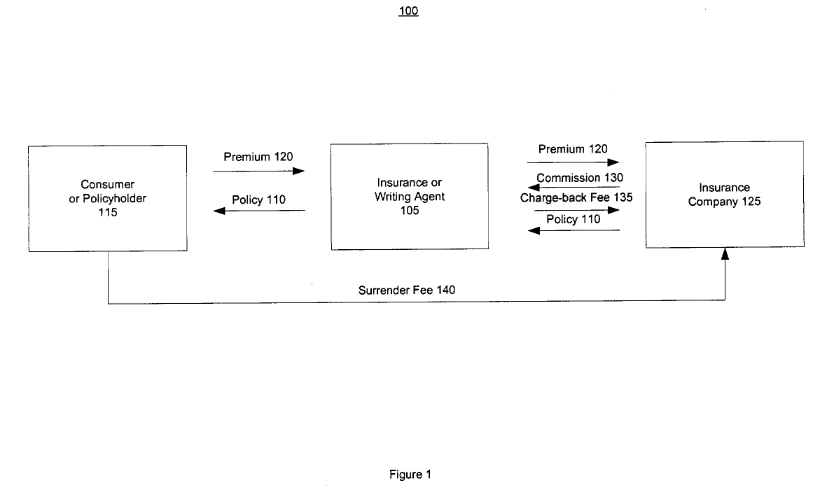

FIG. 1 illustrates the present-day system 100 for paying a commission to an insurance agent. As shown, a writing agent 105 negotiates a policy or other product 110 with a consumer 115 in exchange for a premium 120. As compensation for its services, the insurance company 125 pays the writing agent 105 a commission 130 that typically amounts to a predetermined percentage of premium 120. The commission 130 may be based on other factors. The commission may be paid prior to or after receipt of the premium by either agent 105 or company 125. Arrangement may also be made for company 125 to receive a charge-back fee 135 from agent 105 or a surrender fee 140 from consumer 115, in the event policy 110 is canceled or terminated early.

As previously discussed, system 100 suffers from several drawbacks, including consequential depletion of the insurance company's capital and surplus, decreased efficacy of loss-reduction measures by the insurance company, and reduction of potential business opportunities.

Accordingly, the invention described herein overcomes these and other problems by interposing an intermediate managing agent (or IMA) as an intermediary between the insurance company and the insurance agent. In one embodiment, the IMA may be a third party (TPI). The IMA may function to manage, arrange, coordinate, and/or administer the payment and receipt of agency commissions, for example. The IMA may also pay the insurance agent the up-front commission that traditionally is paid by the insurance company. On the other end, the IMA may receive from the insurance company a trail commission that in the aggregate may be more or less than the commission paid to the insurance agent. The trail commission may, for example, comprise a series of individual payments received over time. Each trail commission payment may be less than the single up-front commission payment paid by the IMA to the agent. For example, the IMA may pay the agent an up-front commission of 6.5% of the premium and receive from the insurance company a trail commission comprising of several payments valued at 1.5% of the premium per annum. The payments may be spread out over a period of time. For accounting purposes, the IMA may recognize the present value of the trail commission as revenue.

The IMA may assume the various risks normally assumed by the insurance company in connection with agency commission payments. At the same time, the insurance company may spread the cost of commissions over a longer period of time, and thus reduce the need to spend its capital and surplus. Even though the insurance company may ultimately pay more in commissions, the accounting and/or economic practicalities are such that the present value of realizing smaller trail commission payments is greater than that of a large up-front payment. The insurance agent, meanwhile, does not notice a difference because the commission is still being paid, only this time by the IMA and not the insurance company. More specific descriptions of the invention's various embodiments are now provided.

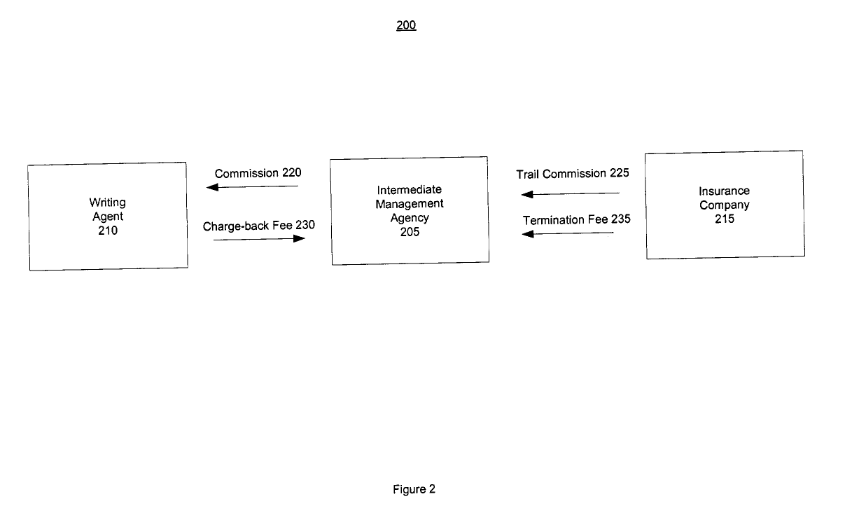

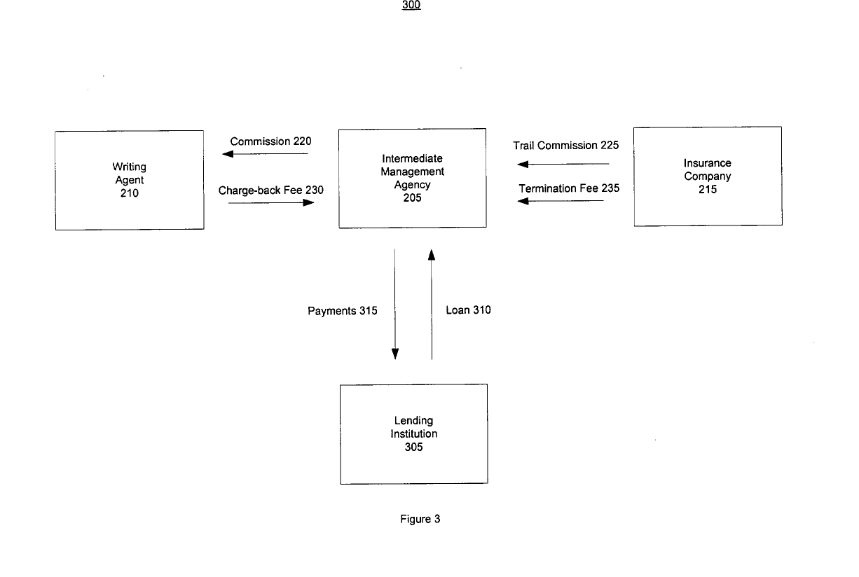

FIG. 2 illustrates one embodiment of the system of the present invention. In this embodiment, an NMA 205 is interposed between writing agent 210 and insurance company 215. In one embodiment, IMA 205 may comprise an individual, company, corporation, partnership, organization, association, or other entity. In another embodiment, insurance company 215 may instead be a participant, such as an individual, company, corporation, partnership, organization, association, or other entity not related to or associated with the insurance industry. In another embodiment, agent 210 may comprise an individual, company, corporation, partnership, organization, association, or other entity not related to or associated with the insurance industry.

According to one embodiment, NMA 205 may pay to writing agent 210 a commission 220 for each policy or product that the agent 210 sells on behalf of insurance company 215. The commission 220 may be predetermined or may be negotiated on a product-by-product basis. For example, the terms of an agency agreement between the writing agent and the IMA may determine the commission 220. Negotiation of commission 220 may involve any or all of agent 210, IMA 205, and insurance company 215. The commission 220 may be paid up-front (i.e., before a product is sold), or, alternatively, after the agent provides the IMA or the insurance company with the premium earned from the sale.

IMA 205 may also receive from insurance company 215 a trail commission 220 that may relate to or be based on a particular policy or product sold by agent 210. Alternatively, trail commission 220 may relate to or be based on a plurality of policies or products sold by any of the insurance company's agents. In one embodiment, the trail commission may relate to or be based on at least one of a premium, a policy account balance, or a policy value amount paid, owed, or held by a consumer in connection with a product sold by the insurance agent. Trail commission 215 may, in an another embodiment, consist of a plurality of individual commission payments that are spread out over a predetermined period of time, such as a period of days, weeks, months, years, or throughout the life of the corresponding product or products, for example. Trail commission 220 may be negotiated prior to or after a policy or product is sold by agent 210. Preferably, each individual trail commission payment is less than the commission 220 paid to agent 210 by IMA 205. In the aggregate, however, trail commission payments may be equal to or greater than commission 220.

IMA may also arrange to receive charge-back fees 230 from agent 210 in the event a policy or product is canceled or terminated early. Likewise, IMA 205 may also arrange to receive termination fees 235 for such cancellations or terminations. Termination fees may be comparable to the surrender fees that exist under the terms of the policy, but there is no necessary relationship. In one embodiment (as shown), termination fees 235 may be recovered from the insurance company. In another embodiment (not shown), surrender fees—in addition to the termination fee received from the insurance company—may be recovered directly from the consumer. Collection of charge-back fees 230 and termination fees 235 may allow IMA 205 to protect or shield itself from losses resulting from early policy or product cancellations or terminations.

FIG. 3 illustrates the system of FIG. 2 with the addition of lending institution 305. In this embodiment, IMA 205 may seek to finance commission 220 with a lending institution 305. In one embodiment, IMA 205 may obtain a loan for the full amount of commission 220, for example. In another embodiment, IMA 205 may negotiate lending rates in an effort to realize greater returns and profitability, particularly vis-à-vis trail commission 225. That is, the aggregate amount of trail commission 225 is preferably greater than the aggregate amount of payments 315. Lending institution may be any bank, credit union, investment group, or other like financial institution or organization.

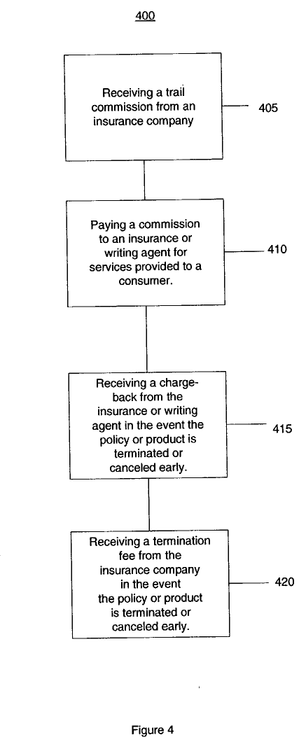

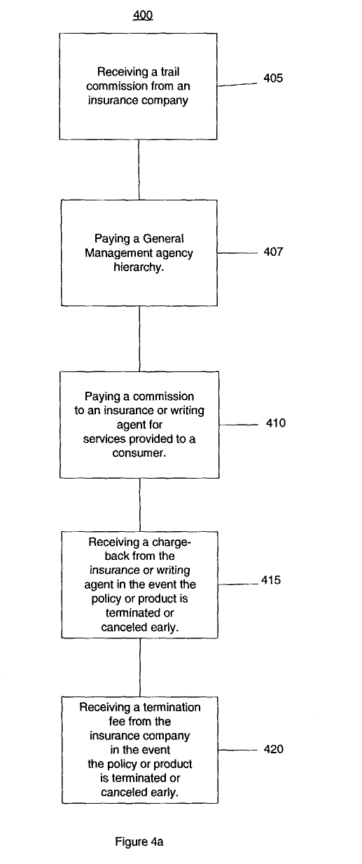

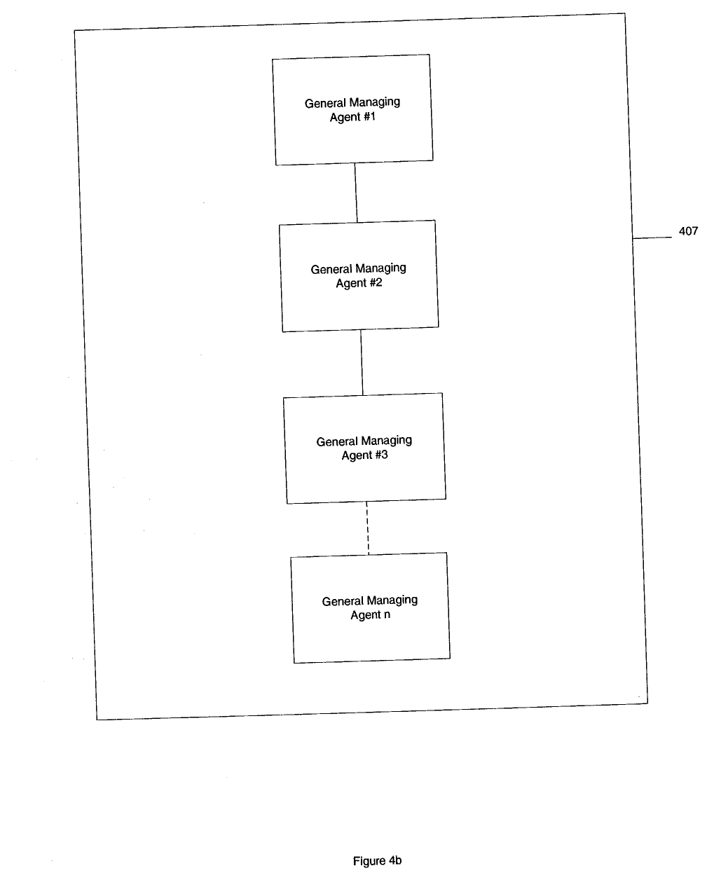

FIG. 4 is a flow chart process 400 for paying a commission to an insurance agent according to the present invention. The perspective shown is that of the IMA 205 shown in FIG. 2. As shown, a trail commission is received by the IMA in step 405. In one embodiment, the trail commission comprises a plurality of individual payments spread out over a predetermined period of time, such as several years, for example. According to one embodiment, the trail commission is received by the IMA from the insurance company. The IMA may negotiate the trail commission rate with the insurance company to ensure favorable terms.

Next, at step 410, an up-front commission is paid to the insurance agent. In one embodiment, the up-front commission is greater than each individual trail commission payment. In another embodiment, the trail commission payments, in the aggregate, are greater than the up-front commission paid by the IMA. In yet another embodiment, the up-front commission is paid prior to initiation of the trail commission payments by the insurance company, i.e., steps 405 and 410 are reversed in order.

In step 415, the IMA may receive a charge-back fee from the agent in the event the policy or product sold is terminated or canceled early. Likewise, in step 420 the IMA may receive a termination fee in the event the policy or product sold is terminated or canceled early. In one embodiment, the termination fee is charged to the insurance company. In another embodiment (not shown), a surrender fee is charged directly to the consumer of the policy or product.

FIG. 4a is the flow chart process 400 of FIG. 4, further including a step 407—paying a hierarchy of one or more general managing agents (GMAs) interposed between the IMA and the writing agent (FIG. 4b is a block diagram illustrating a sample hierarchy of GMAs.) According to one embodiment, step 407 may comprise paying a plurality of GMAs. According to one embodiment, an up-front commission payment may be made by the IMA to the highest level GMA in the hierarchy who has a relationship with the IMA, e.g., GMA #1 in FIG. 4b. GMA #1 may, in turn, pass some or all of the up-front commission to the next GMA in the hierarchy, i.e., GMA #2, which in turn may pass some or all of the commission to GMA #3. This process may continue until such time as the last GMA in the hierarchy (e.g., GMA #n) passes some portion or all of the up-front commission to the writing agent, as shown in step 410 of FIG. 4a. According to another embodiment, the writing agent may reside at any point within the GMA hierarchy.

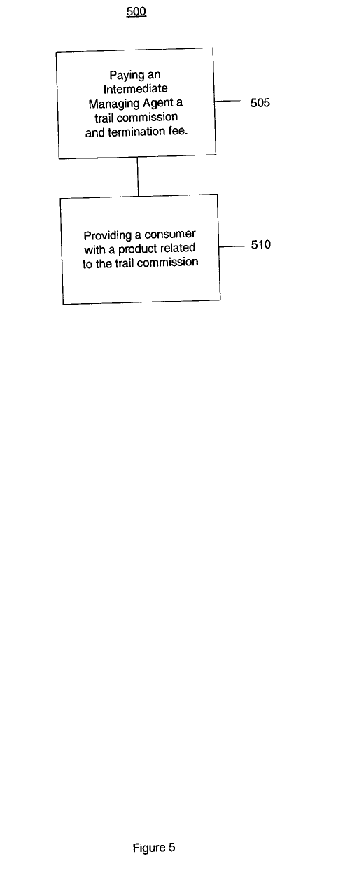

FIG. 5 is a flow chart process 500 for paying a commission according to the present invention. The perspective shown is that of the insurance company 215 shown in FIG. 2. At step 505, the insurance company 215 pays an IMA a trail commission. In one embodiment, the insurance company 215 negotiates with the IMA as to the exact trail commission to be paid. Preferably, the trail commission negotiated will permit the IMA to financially justify its payment of a commission directly to the agent. The insurance company may also pay a termination fee to the IMA in the event of the early cancellation or termination of the policy. At step 510, the insurance company 215 provides a consumer with the policy or product purchased. In another embodiment, the policy or product purchased is provided to the consumer prior to initiation of trail commission payments.

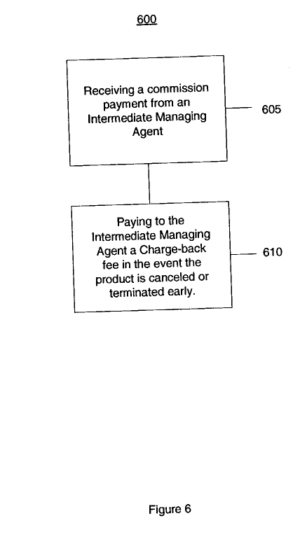

FIG. 6 is a flow chart process 600 for receiving a commission according to the present invention. The perspective shown is that of the insurance agent 210 shown in FIG. 2. In this process, the insurance agent interacts with an IMA in connection with payment of an up-front commission. In one embodiment, the commission is paid by the IMA directly to the agent. In another embodiment, the IMA and the agent exclusively negotiate the commission. In another embodiment, the insurance company may also take part in the negotiations. According to one embodiment, the IMA may pay a portion or all of a commission to a hierarchy of GMAs interposed between the IMA and the insurance agent, as shown in FIGS. 4a and 4b.

At step 610, the insurance agent may pay the IMA a charge-back fee in the event the product is canceled or terminated early.

Other embodiments, uses and advantages of the present invention will be apparent to those skilled in the art from consideration of the specification and practice of the invention disclosed herein. The specification and examples should be considered exemplary only. The intended scope of the invention is only limited by the claims appended hereto.

What is claimed is:

1. A method for paying a commission to an insurance agent, the method comprising:
receiving a trail commission from an insurance company, the trail commission being related to or based on at least one of a premium, a policy account balance, or a policy value amount paid, owed, or held by a consumer in connection with a product sold by the insurance agent; and
paying the insurance agent the commission in exchange for services provided to the consumer.

2. The method of claim 1 wherein the trail commission comprises a plurality of payments paid out over a period of time.

3. The method of claim 2 wherein the period of time comprises the life of the product sold.

4. The method of claim 2 wherein the period of time is predetermined.

5. The method of claim 1 wherein each individual trail commission payment is less than the commission paid to the insurance agent.

6. The method of claim 1 wherein the total amount of trail commission payments is greater than the commission paid to the insurance agent.

7. The method of claim 1 wherein the up-front commission is paid to the insurance agent before the trail commission is received.

8. The method of claim 1 further comprising the step of receiving a charge-back from the insurance agent in the event the product is terminated or canceled early.

9. The method of claim 1 further comprising the step of receiving a surrender termination fee from the insurance company in the event the product is terminated or canceled early.

10. The method of claim 1 wherein the commission paid to the insurance agent is financed through a lending institution.

11. A method for paying a commission, the method comprising:
paying an intermediate managing agent a trial commission, the trial commission being related to or based on a premium paid by a consumer in connection with a product sold by an insurance agent.

12. The method of claim 11 wherein the trail commission comprises a plurality of payments paid out over a period of time.

13. The method of claim 12 wherein the period of time comprises the life of the product sold.

14. The method of claim 12 wherein the period of time is predetermined.

15. A method for receiving a commission, the method comprising:
receiving the commission payment from an intermediate managing agent in exchange for services rendered to a consumer in connection with the purchasing of an insurance company product.

16. The method of claim 15 further comprising the step of paying to the intermediate managing agent a charge-back fee in the event the product is canceled or terminated early.

17. The method of claim 15 wherein the charge-back fee amount decreases with time.

18. The method of claim 15 wherein the commission payment is financed through a lending institution.

19. The method of claim 15 wherein the intermediate management agency receives a trail commission from the insurance company.

20. A system for paying a commission to an insurance agent, the system comprising:
an intermediate managing agent interposed between the insurance agent and an insurance company, the intermediate managing agent receiving a trail commission from the insurance company, the trail commission being related to or based on a premium paid by a consumer in connection with a product sold by the insurance agent, the intermediate managing agent further paying the insurance agent the commission in exchange for services provided to the consumer.

21. The system of claim 20 wherein the trail commission comprises a plurality of individual payments paid out over time.

22. The system of claim 21 wherein the period of time comprises the life of the product sold.

23. The system of claim 21 wherein the trail commission is paid periodically.

24. The system of claim 21 wherein the period of time is predetermined.

25. The system of claim 21 wherein each individual trail commission payment is less than the commission paid to the insurance agent.

26. The system of claim 21 wherein the total amount of trail commission payments is greater than the commission paid to the insurance agent.

27. The system of claim 20 wherein the commission is paid to the insurance agent before the trail commission is received.

28. The system of claim 20 further comprising the step of receiving a charge-back from the insurance agent in the event the product is terminated or canceled early.

29. The system of claim 20 further comprising the step of receiving a surrender fee from at least one of the consumer and the insurance company in the event the product is terminated or canceled early.

30. The system of claim 20 wherein the commission is financed through a lending institution.

31. A method for paying a commission to an insurance agent, the method comprising:
receiving a trail commission from an insurance company, the trail commission being related to or based on at least one of a premium, a policy account balance, or a policy value amount paid, owed, or held by a consumer in connection with a product sold by the insurance agent;
paying at least one general managing agent some portion or all of the commission; and
paying the insurance agent some or all of the commission in exchange for services provided to the consumer.

32. A method for paying a commission to an insurance agent, the method comprising:
receiving a trail commission from an insurance company, the trail commission being related to or based on at least one of a premium, a policy account balance, or a policy value amount paid, owed, or held by a consumer in connection with a product sold by the insurance agent; and
paying at least one general managing agent and an insurance agent some portion or all of the commission.

33. The method of claim 32 wherein the general managing agent receives some or all of the commission from the insurance managing agent and pays some or all of the commission to at least one of a second general managing agent and the insurance agent.

34. A method for paying a commission to an agent, the method comprising:
receiving a trail commission from a participant; and
paying the agent the commission.

35. The method of claim 34 wherein the participant comprises an individual, company, corporation, partnership, organization, association, or other entity.

36. The method of claim 34 wherein the agent comprises an individual, company, corporation, partnership, organization, association, or other entity.

37. A system for paying a commission to an agent, the system comprising:
an intermediate managing agent interposed between the agent and a participant, the intermediate managing agent receiving a trail commission from the participant and paying the agent the commission.

38. The system of claim 37 wherein the participant comprises an individual, company, corporation, partnership, organization, association, or other entity.

39. The system of claim 37 wherein the agent comprises an individual, company, corporation, partnership, organization, association, or other entity.
